(19) United States
(12) Patent Application Publication
(10) Pub. No.: US 2020/0219508 A1
(43) Pub. Date: Jul. 9, 2020

(54) METHOD FOR COMMANDING A PLURALITY OF VIRTUAL PERSONAL ASSISTANTS AND ASSOCIATED DEVICES

(71) Applicant: FAURECIA INTERIEUR INDUSTRIE, Nanterre (FR)

(72) Inventors: Omar BEN ABDELAZIZ, Tille (FR); David PEREIRA, Meru (FR)

(21) Appl. No.: 16/735,250

(22) Filed: Jan. 6, 2020

(30) Foreign Application Priority Data
Jan. 4, 2019 (FR) 19 00081

(51) Int. Cl. G10L 15/22; G10L 15/30; G10L 15/18

(52) U.S. Cl. CPC G10L 15/22; G10L 2015/223; G10L 15/1815; G10L 15/30

(57) ABSTRACT

A method for commanding a plurality of virtual personal assistants, the commanding method being carried out by a control system, the control system being adapted to communicate with each virtual personal assistant, the control system in particular being a control system embedded in a vehicle. The method includes the steps of: receiving a request from a user, the request including a message; selecting a virtual personal assistant as a function of the message; obtaining a selected virtual personal assistant; and sending a command to the selected virtual personal assistant.

This patent application claims the benefit of document FR 19 00081 filed on Jan. 4, 2019 which is hereby incorporated by reference.

### TECHNICAL FIELD

The present invention relates to a method for commanding a plurality of virtual personal assistants. The present invention also relates to a method for performing an action including carrying out the commanding method as well as an associated system for controlling a vehicle, vehicle, assembly, computer program product and information medium.

### BACKGROUND

Virtual personal assistants are computer tools having the ability to perform tasks or services for an individual. Virtual personal assistants are usable in multiple contexts such as providing information, playing videos, making online purchases or managing calls in the context of a call center.

Typically, virtual personal assistants are classified into two categories: generic and specific. A generic virtual personal assistant is capable of performing tasks in several contexts, while a specific virtual personal assistant can be used in a single context and proposes dedicated tasks that are not available on generic virtual personal assistants.

However, in practice, even in a specific context, in particular on board a vehicle, the user wishes to have specific services dedicated to the specific context as well as generic services to which a generic virtual personal assistant provides access.

### SUMMARY

There is therefore a need for a method for controlling a plurality of virtual personal assistants allowing a user, in particular a vehicle driver, to benefit from services of a generic virtual personal assistant and a specific virtual personal assistant.

To that end, the present disclosure relates to a method for commanding a plurality of virtual personal assistants, the commanding method being carried out by a control system, the control system being adapted to communicate with each virtual personal assistant, the control system in particular being a control system embedded in a vehicle, the method including the steps of receiving a request from a user, the request including a message, selecting a virtual personal assistant as a function of the message, obtaining a selected virtual personal assistant, and sending a command to the selected virtual personal assistant.

According to specific embodiments, the command method includes one or more of the following features, considered alone or according to any technically possible combinations:
the selection step includes a semantic analysis of the message in order to obtain interpreted content of the message, the selected virtual personal assistant being a function of the interpreted content.
the selection includes a comparison of the interpreted content with a set of possible actions, a possible action being an action able to be performed by at least one virtual personal assistant.
the method further includes a step for automatic recognition of the speech applied to the message.
at least one of the virtual personal assistants is implemented by a terminal or by a server.
at least one among the message and the command include(s) an identifier able to activate the implementation of a virtual personal assistant.
the control system includes a memory and a calculator, the memory and the calculator being able to interact to implement at least one virtual personal assistant among the plurality of virtual personal assistants.

The present disclosure also describes a method for performing an action, the performance method including the steps for implementing the command method as previously described, the message and the command including information on the action to be performed, reception of the command by the selected virtual personal assistant, and execution of the action by the selected virtual personal assistant.

The present disclosure also relates to a control system able to communicate with a plurality of virtual personal assistants, the control system being adapted to command each virtual personal assistant, the control system being adapted to receive a request from a user, the request including a message, selecting a virtual personal assistant as a function of the message, obtaining a selected virtual personal assistant, and sending a command to the selected virtual personal assistant.

The present disclosure also discloses a vehicle including a control system as previously disclosed.

The present disclosure also relates to an assembly including a control system as previously disclosed and a plurality of elements, each element being a terminal or a server and being able to implement at least one of the virtual personal assistants.

The present disclosure also relates to a computer program product including a readable information medium, on which a computer program is stored comprising program instructions, the computer program being able to be loaded on a data processing unit and adapted to drive the implementation of at least one step of a method as previously described when the computer program is implemented on the data processing unit.

The present disclosure also relates to a readable information medium including program instructions forming a computer program, the computer program being able to be loaded on a data processing unit and adapted to drive the implementation of at least one step of a method as previously disclosed when the computer program is implemented on the data processing unit.

### BRIEF DESCRIPTION OF THE DRAWINGS

Other features and advantages of the invention will appear upon reading the following description of embodiments of the invention, provided as an example only and in reference to the drawings, which are:

FIG. 1, a schematic illustration of an assembly including a vehicle, terminals and a server, and

FIG. 2, a flowchart of an exemplary embodiment of an execution method by the assembly of FIG. 1.

### DETAILED DESCRIPTION

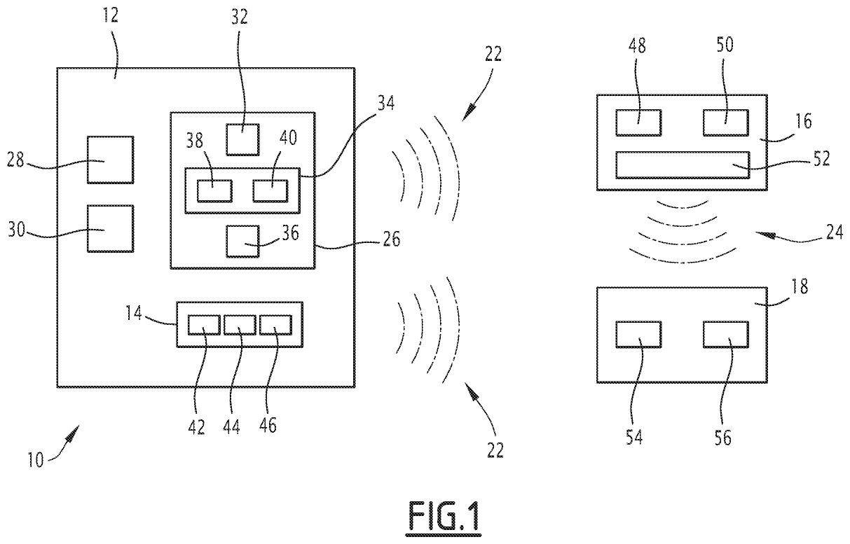

An assembly 10 is shown in FIG. 1. The assembly 10 includes a vehicle 12, a first terminal 14, a second terminal 16 and a server 18.

In the specific example of FIG. 1, the first terminal 14 is located in the inner space of the vehicle 12 while the second terminal 16 and the server 18 are located outside the vehicle 12.

The vehicle 12 and each other element 14, 16 and 18 are able to communicate with one another, for example by radio waves. This is shown schematically in FIG. 1 by the arcs of circle 22.

Alternatively, the expression “able to” may also be present hereinafter using the expression “adapted to”.

Furthermore, in the proposed example, the other elements 14, 16 and 18 are also able to communicate with one another. The arcs of circle 24 show, as an illustration, exchanges between the second terminal 16 and the server 18.

In the described example, the vehicle 12 is a motor vehicle.

The vehicle 12 includes a control system 26, a first member 28 and a second member 30.

The control system 26 is able to control the various members of the vehicle 12.

As an illustration, in the illustrated case, the control system 26 is able to control the members 28 and 30, which are for example members commanding the position of the side windows of the vehicle 12 relative to their corresponding leaf.

According to one particular example, the control system 26 is an engine control unit (ECU). In such a case, the control system 26 is able to control actuators on an internal combustion engine.

The control system 26 includes a receiver 32, a processing unit 34 and a virtual personal assistant 36.

According to the example of FIG. 1, the receiver 32 is a microphone.

The microphone 32 is able to receive an acoustic signal and to convert the received acoustic signal into an electrical signal.

The microphone 32 is also able to send the electrical signal to the processing unit 34.

The processing unit 34 is an electronic calculator able to manipulate and/or transform data represented as electronic or physical quantities in registers of the system and/or memories into other similar data corresponding to physical data in the memories, registers or other types of display, transmission or storage devices.

As shown in FIG. 1, the processing unit 34 includes a calculator 38 and a memory 40.

The calculator 38 also includes a data processing subunit and an information medium reader. The control system 26 also comprises a keyboard and a display unit.

The computer program product includes a readable information medium.

A readable information medium is a medium readable by the system, usually by the data processing unit. The readable information medium is a medium adapted to storing electronic instructions and able to be coupled with a bus of a computer system.

As an example, the readable information medium is a floppy disk, an optical disc, a CD-ROM, a magnetic-optical disc, a ROM memory, a RAM memory, an EPROM memory, an EEPROM memory, a magnetic card or an optical card.

A computer program comprising program instructions is stored on the readable information medium.

The computer program can be loaded on the data processing subunit and the memory 40 and is adapted to drive the implementation of calculations or specific operations when the computer program is implemented on the data processing unit.

The virtual personal assistant 36 is a tool capable of performing tasks or services for the driver of the vehicle 12.

A virtual personal assistant 36 is often referred to using the acronym VPA.

According to the proposed example, the virtual personal assistant 36 is a specific virtual personal assistant adapted to perform tasks or services specific to the context of the automobile.

The virtual personal assistant 36 is a program having instructions stored in the memory 40 after loading.

The memory 40 and the calculator 38 are able to interact to implement the virtual personal assistant 36.

For clarity reasons and because the virtual personal assistant 36 is specific, the virtual personal assistant 36 is shown in the form of an independent block, although the virtual personal assistant 36 strictly belongs to the elements 38 and 40.

The first terminal 14 is a smartphone.

A smartphone is a mobile terminal capable of performing certain functions of a laptop calculator.

As previously indicated, the first terminal 14 is located in the vehicle 14, for example held by a hands-free holder.

The first terminal 14 includes a calculator 42, a memory 44 and a man-machine interface 46.

The calculator 42 and the memory 44 of the first terminal 14 are able to interact to implement a first generic virtual personal assistant VPA1.

The man-machine interface 46 is for example a touch-sensitive screen.

The second terminal 16 is a connected speaker.

A connected speaker is a smart device making it possible to control several elements of a house from a voice command. Such an enclosure is often referred to as smart speaker.

In the proposed example, the second terminal 16 is located outside the space of the vehicle 12, for example in the house of the driver.

The second terminal 16 includes a calculator 48, a memory 50 and a man-machine interface 52.

The calculator 48 and the memory 50 of the second terminal 16 are able to interact to implement a second generic virtual personal assistant VPA2.

The man-machine interface 52 is for example a touch-sensitive screen.

The server 18 is a computer device offering services to one or several clients.

In the proposed example, the server 18 is a messaging server.

The server 18 includes a calculator 54 and a memory 56.

The calculator 54 and the memory 56 of the server 18 are able to interact to implement a third generic virtual personal assistant VPA3.

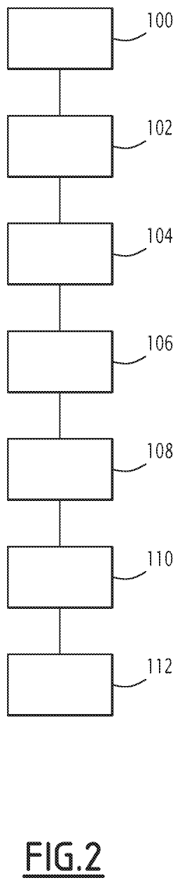

The operation of the assembly 10 is now described in reference to FIG. 2, which is a flowchart illustrating one example embodiment of a method for executing an action.

The method includes a first receiving step 100, a recognition step 102, a selection step 104, a sending step 106, a second receiving step 108, a processing step 110 and an execution step 112.

During the first receiving step 100, the microphone 32 receives a request from the driver.

The drivers sends a voice command including information on the action that the driver wishes to see performed by one of the personal digital assistants 36, VPA1, VPA2 or VPA3.

In the proposed example, the driver gives the action itself as information.

The message is converted by the microphone 32 into an electrical signal that is sent to the processing unit 42.

The recognition step 102 is then carried out by the processing unit 42.

During such a step, an automatic speech recognition step is used. This is a computer technique that makes it possible to analyze the human voice detected using a microphone to transcribe it in the form of text usable by a machine.

The processing unit 42 applies automatic speech recognition to the voice message.

The content of the message is thus accessible to the control system 26.

During the selection step 104, the control system 26 selects a personal digital assistant 36, VPA1, VPA2 or VPA3 as a function of the message.

Several selection examples are given hereinafter.

According to a first example, the message is an identifier able to activate the implementation of a virtual personal assistant 36, VPA1, VPA2 or VPA3.

Such an identifier is often a word specific to the virtual personal assistant 36, VPA1, VPA2 or VPA3 in question.

In such a case, the control system 26 selects the virtual personal assistant 36, VPA1, VPA2 or VPA3 corresponding to the identifier.

According to a second example corresponding to the case of FIG. 2, the message includes the action to be performed. In such an example, the control system 26 selects a virtual personal assistant 36, VPA1, VPA2 or VPA3 capable of performing the action.

According to a third example based on the second example, a preference rule is established seeking to favor one of the virtual personal assistance 36, VPA1, VPA2 or VPA3. When several virtual personal assistants 36, VPA1, VPA2 or VPA3 are capable of performing the action, the preferred virtual personal assistant 36, VPA1, VPA2 or VPA3 is chosen.

According to a fourth example, the message includes several actions to be performed. In such a scenario, the control system 26 selects a virtual personal assistant 36, VPA1, VPA2 or VPA3 capable of performing each of the actions. Otherwise, the control system 26 selects the virtual personal assistants 36, VPA1, VPA2 or VPA3 making it possible to minimize the number of virtual personal assistants 36, VPA1, VPA2 or VPA3 to perform the action.

According to a fifth example, the message includes a context, for example house or car. In such a case, the control system 26 interprets the content to determine associated actions thereof and selects the most appropriate virtual personal assistant 36, VPA1, VPA2 or VPA3.

For the case of the house, the control system 26 preferably selects the second virtual personal assistant VPA2 inasmuch as the latter is already located in the house. Contrariwise, for the context of the car, the specific virtual personal assistant 36 is the most appropriate.

In each case, the selection step 104 includes a semantic analysis of the message.

For example, the order “roll up the window” and the order “open the window” are to be interpreted identically even though the wording is different between the two propositions.

After such a semantic analysis, an interpreted content of the message is thus obtained.

The selection step 104 then includes the comparison of the interpreted content with the possible interpreted contents, each possible interpreted content being associated with at least one virtual personal assistant 36, VPA1, VPA2 or VPA3.

In the aforementioned examples, the possible interpreted contents are actions and a possible interpreted content being associated with a virtual personal assistant 36, VPA1, VPA2 or VPA3 when the virtual personal assistant 36, VPA1, VPA2 or VPA3 is capable of carrying out the considered action.

When the interpreted content is identical to a possible action, the virtual personal assistant 36, VPA1, VPA2 or VPA3 associated with the possible action is selected.

According to one particular embodiment, the comparison is carried out sequentially.

The comparison is done first for the possible actions of the active virtual personal assistant 36, VPA1, VPA2 or VPA3 then, in the case where the interpreted content is not present in the possible actions of the active virtual personal assistant 36, VPA1, VPA2 or VPA3, a comparison is done with the possible actions of the inactive virtual personal assistants 36, VPA1, VPA2 or VPA3.

In a variant or additionally, the comparison includes a test relative to the presence of an action related to a specific context. Typically, in the proposed case, if the interpreted content includes a word related to the vehicle 12 (in particular an element of the vehicle 12), the specific virtual personal assistant 36 is selected.

At the end of the selection step 104, one of the virtual personal assistants 36, VPA1, VPA2 or VPA3 is selected.

In the case where no virtual personal assistant 36, VPA1, VPA2 or VPA3 is capable of performing the requested action, the control system 26 returns a warning signal to the driver.

The sending step 106 is then carried out.

The control system 26 sends a command to the selected virtual personal assistant 36, VPA1, VPA2 or VPA3.

For the case of the specific virtual personal assistant 36, the sending is done by sending a command to the calculator 38 while for the other virtual personal assistants VPA1, VPA2 or VPA3, the sending is done by sending radiofrequency waves to terminals 14, 16 or the corresponding server 18.

The nature of the command also varies depending on the case.

For example, the command consists of activating the selected virtual personal assistant 36, VPA1, VPA2 or VPA3 by sending the appropriate identifier.

According to another example, the command includes information on the action to be performed. In one preferred embodiment, the information on the action to be performed is the information that is contained in the voice message from the driver.

The selected virtual personal assistant 36, VPA1, VPA2 or VPA3 then receives the command during the second receiving step 108.

In the proposed example, the selected virtual personal assistant 36, VPA1, VPA2 or VPA3 implements the processing step 110.

The processing step 110 for example consists of processing the received message or requesting additional information from the driver, in particular via the control system 26 if the selected virtual personal assistant 36, VPA1, VPA2 or VPA3 is located at a distance from the vehicle.

At the end of the processing step 110, the action to be performed by the selected virtual personal assistant 36, VPA1, VPA2 or VPA3 is obtained.

In certain cases, as of the second receiving step 108, the received message includes the action such that the processing step 110 is then not implemented.

During the performance, the action is executed by the virtual personal assistant 36, VPA1, VPA2 or VPA3.

For example, if the driver wishes to turn on the radiators in his house, the second virtual personal assistant VPA2 commands the radiators as of receipt of the command from the control system 26.

According to one specific embodiment, the control system 26 notifies the driver that the action has been performed, for example by a sound signal.

The method for performing an action therefore allows a driver to control, via a single system that is the control system 26, each virtual personal assistant 36, VPA1, VPA2 or VPA3 that the driver has.

The control system 26 therefore allows the driver to control a plurality of virtual personal assistants in order to benefit from services of a generic virtual personal assistant VPA1, VPA2 or VPA3 and a specific virtual personal assistant 36.

The control system 26 does not impose any constraint on the virtual personal assistants such that any virtual personal assistant can be used in interaction with the control system 26.

Due to such compatibility, the update of each virtual personal assistant is made easier.

This further makes it possible to perform the actions in the vehicle 12 with a specific virtual personal assistant 36, which increases the safety of the vehicle 12 relative to the use of a generic virtual personal assistant VPA1, VPA2 or VPA3.

The control proposed by the control system 26 is also easy, since the control system 26 is capable of managing the activation identifiers of each virtual personal assistant. The driver can use each generic virtual personal assistant VPA1, VPA2 or VPA3 the same way that he would in another context, resulting in easier use, without any additional learning being required for the driver.

1. A method for commanding a plurality of virtual personal assistants, the commanding method being carried out by a control system, the control system being adapted to communicate with each virtual personal assistant, the method comprising:
receiving a request from a user, the request including a message,
selecting a virtual personal assistant as a function of the message, to obtain a selected virtual personal assistant, and
sending a command to the selected virtual personal assistant.

2. The command method according to claim 1, wherein the control system is a control system embedded in a vehicle.

3. The command method according to claim 1, wherein the selection includes a semantic analysis of the message in order to obtain interpreted content of the message, the selected virtual personal assistant being a function of the interpreted content.

4. The command method according to claim 1, wherein the selection includes a comparison of the interpreted content with a set of possible actions, a possible action being an action able to be performed by at least one virtual personal assistant.

5. The command method according to claim 1, wherein the method further includes a step for automatic recognition of the speech applied to the message.

6. The command method according to claim 1, wherein at least one of the virtual personal assistants is implemented by a terminal or by a server.

7. The command method according to claim 1, wherein at least one among the message and the command include(s) an identifier able to activate the implementation of a virtual personal assistant.

8. A method for performing an action, the performance method comprising the following steps:
implementing the command method according to claim 1, the message and the command including information on the action to be performed,
reception of the command by the selected virtual personal assistant, and
execution of the action by the selected virtual personal assistant.

9. A control system able to communicate with a plurality of virtual personal assistants, the control system being adapted to:
receive a request from a user, the request including a message,
select a virtual personal assistant as a function of the message, obtaining a selected virtual personal assistant, and
send a command to the selected virtual personal assistant.

10. The control system according to claim 9, wherein the control system is adapted to command each virtual personal assistant.

11. A vehicle including a control system according to claim 9.

12. An assembly including a control system according to claim 9 and a plurality of elements, each element being a terminal or a server and being able to implement at least one of the virtual personal assistants.

13. A computer program product including a readable information medium, on which a computer program is stored comprising program instructions, the computer program being able to be loaded on a data processing unit and adapted to drive the implementation of at least one step of a method according to claim 1 when the computer program is implemented on the data processing unit.

14. A readable information medium including program instructions forming a computer program, the computer program being able to be loaded on a data processing unit and adapted to drive the implementation of at least one step of a method according to claim 1 when the computer program is implemented on the data processing unit.
